(19) United States
(12) Patent Application Publication
(10) Pub. No.: US 2018/0295338 A1
(43) Pub. Date: Oct. 11, 2018

(54) DEPTH PROCESSING SYSTEM CAPABLE OF CAPTURING DEPTH INFORMATION FROM MULTIPLE VIEWING POINTS

(71) Applicant: eYs3D Microelectronics, Co., Taipei City (TW)

(72) Inventor: Chi-Feng Lee, Hsinchu County (TW)

(21) Appl. No.: 15/949,087

(22) Filed: Apr. 10, 2018

Related U.S. Application Data
(60) Provisional application No. 62/483,472, filed on Apr. 10, 2017.
(60) Provisional application No. 62/511,317, filed on May 25, 2017.

(51) Int. Cl. H04N 13/117; H04N 13/156; G06T 17/10; G06K 9/00; H04N 13/167

(52) U.S. Cl. CPC H04N 13/117; H04N 13/156; H04N 2013/0081; G06K 9/00355; H04N 13/167; G06T 17/10

(57) ABSTRACT

A depth processing system includes a plurality of depth capturing devices and a host. The depth capturing devices are disposed around a specific region, and each generates a piece of depth information according to its own corresponding viewing point. The host combines a plurality of pieces of depth information generated by the plurality of depth capturing devices to generate a three-dimensional point cloud corresponding to the specific region according a relative space status of the plurality of depth capturing devices.

### CROSS REFERENCE TO RELATED APPLICATIONS

This non-provisional application claims priority of US provisional applications U.S. 62/483,472, filed on Apr. 10, 2017, and U.S. 62/511,317, filed on May 25, 2017, included herein by reference in its entirety.

### BACKGROUND OF THE INVENTION

### 1. Field of the Invention

This invention is related to a depth processing system, and more particularly, a depth processing system capable of capturing depth information from multiple viewing points.

### 2. Description of the Prior Art

As the demand for all kinds of applications on electronic devices increases, deriving the depth information for the exterior objects becomes a function required by many electronic devices. For example, once the depth information of the exterior objects, that is, the information about the distances between the objects and the electronic device is obtained, the electronic device can identify objects, combine images, or implement different kinds of application according to the depth information. Binocular vision, structured light, and time of flight (ToF) are few common ways to derive depth information nowadays.

However, in prior art, since the depth processor can derive the depth information corresponding to the electronic device from one single view point, there may be blind spots and the real situations of the exterior objects cannot be known. In addition, the depth information generated by the depth processor of the electronic device can only represent its own observing result and cannot be shared with other electronic devices. That is, to derive the depth information, each of the electronic devices should need its own depth processor. Consequently, it is difficult to integrate the resources and complicated for designing the electronic devices.

### SUMMARY OF THE INVENTION

One embodiment of the present invention discloses a depth processing system. The depth processing system includes a plurality of depth capturing devices and a host.

The depth capturing devices are disposed around a specific region, and each generates a piece of depth information according to its own corresponding viewing point. The host combines a plurality of pieces of depth information generated by the plurality of depth capturing devices to generate a three-dimensional point cloud corresponding to the specific region according a relative space status of the plurality of depth capturing devices.

Another embodiment of the present invention discloses a depth processing system. The depth processing system includes a plurality of depth capturing devices and a host.

The depth capturing devices are disposed around a specific region, and each generates a piece of depth information according to its own corresponding viewing point. The host controls the capturing times at which the depth capturing devices capture a plurality of pieces of depth information, and combines the plurality of pieces of depth information to generate a three-dimensional point cloud corresponding to the specific region according to a relative space status of the plurality of depth capturing devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a depth processing system according to one embodiment of the present invention.

FIG. 2 shows the timing diagram of the first capturing times of the depth capturing devices.

FIG. 3 shows the timing diagram of the second capturing times for capturing the pieces of second depth information.

FIG. 4 shows a usage situation when the depth processing system in FIG. 1 is adopted to track the skeleton model.

FIG. 5 shows a depth processing system according to another embodiment of the present invention.

FIG. 6 shows the three-dimensional point cloud generated by the depth processing system in FIG. 5.

FIG. 7 shows a flow chart of an operating method of the depth processing system in FIG. 1 according to one embodiment of the present invention.

FIG. 8 shows a flow chart for performing the synchronization function according to one embodiment of the present invention.

FIG. 9 shows a flow chart for performing the synchronization function according to another embodiment of the present invention.

### DETAILED DESCRIPTION

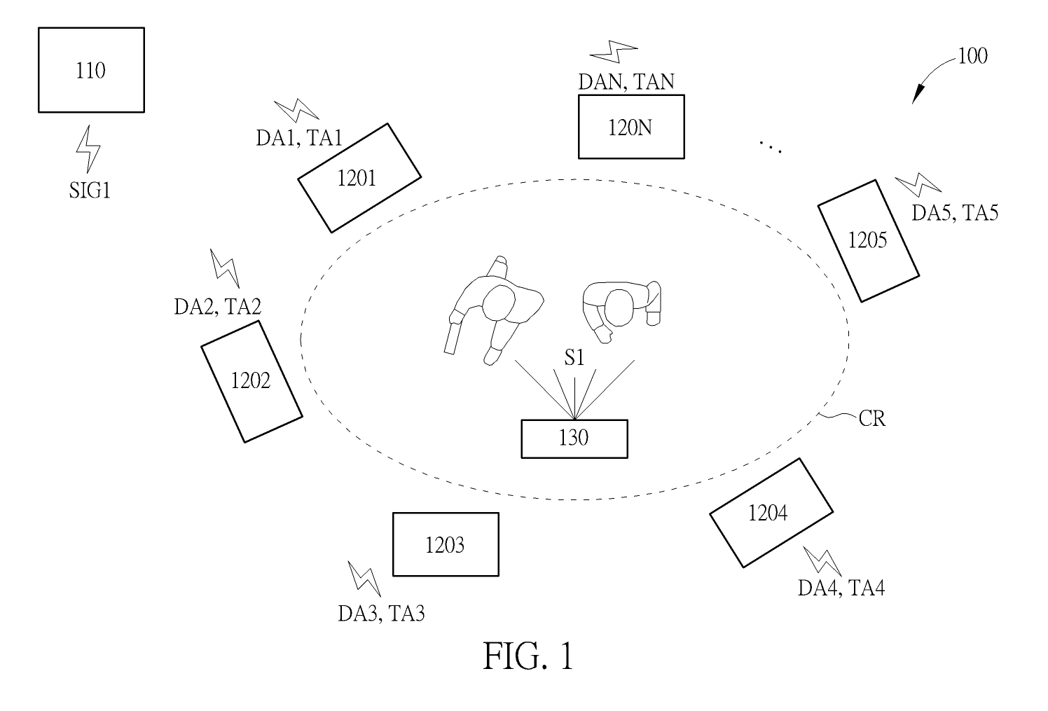

FIG. 1 shows a depth processing system 100 according to one embodiment of the present invention. The depth processing system 100 includes a host 110 and a plurality of depth capturing devices 1201 to 120N, where N is an integer greater than 1.

The depth capturing devices 1201 to 120N can be disposed around a specific region CR, and the depth capturing devices 1201 to 120N each can generate a piece of depth information of the specific region CR according to its own corresponding viewing point. In some embodiments of the present invention, the depth capturing devices 1201 to 120N can use the same approach or different approaches, such as binocular vision, structured light, time of flight (ToF), etc., to generate the depth information of the specific region CR from different viewing points. The host can transform the depth information generated by the depth capturing devices 1201 to 120N into the same space coordinate system according to the positions and the capturing angles of the depth capturing devices 1201 to 120N, and further combine the depth information generated by the depth capturing devices 1201 to 120N to generate the three-dimensional (3D) point cloud corresponding to the specific region CR to provide completed 3D environment information of the specific region CR.

In some embodiments, the parameters of the depth capturing devices 1201 to 120N, such as the positions, the capturing angles, the focal lengths, and the resolutions, can be determined in advance so these parameters can be stored in the host in the beginning, allowing the host 110 to combine the depth information generated by the depth capturing devices 1201 to 120N reasonably. In addition, since the positions and capturing angles may be slightly different when the depth capturing devices 1201 to 120N are practically installed, the host 110 may perform a calibration function to calibrate the parameters of the depth capturing devices 1201 to 120N, ensuring the depth information generated by the depth capturing devices 1201 to 120N can be combined jointly. In some embodiments, the depth information may also include color information.

In addition, the object in the specific region CR may move so the host 110 has to use the depth information generated by the depth capturing devices 1201 to 120N at similar times to generate the correct 3D point cloud. To control the depth capturing devices 1201 to 120N to generate the depth information synchronously, the host 110 can perform a synchronization function.

When the host 110 performs the synchronization function, the host 110 can, for example, transmit a first synchronization signal SIG1 to the depth capturing devices 1201 to 120N. In some embodiments, the host 110 can transmit the first synchronization signal SIG1 to the depth capturing devices 1201 to 120N through wireless communications, wired communications, or both types of communications. After receiving the first synchronization signal SIG1, the depth capturing devices 1201 to 120N can generate pieces of first depth information DA1 to DAN and transmit the pieces of first depth information DA1 to DAN along with the first capturing times TA1 to TAN of capturing the pieces of first depth information DA1 to DAN to the host 110.

In the present embodiment, from capturing information to completing the depth information generation, the depth capturing devices 1201 to 120N may require different lengths of time; therefore, to ensure the synchronization function to effectively control the depth capturing devices 1201 to 120N for generating the depth information synchronously, the first capturing times TA1 to TAN of capturing the pieces of first depth information DA1 to DAN should be the times at which the pieces of the first depth information DA1 to DAN are captured, instead of the times at which the pieces of the first depth information DA1 to DAN are generated.

In addition, since the distances via the communication paths to the host 110 may be different for the depth capturing devices 1201 to 120N, and the physical conditions and the internal processing speeds may also be different, the depth capturing devices 1201 to 120N may receive the first synchronization signal SIG1 at different times, and the first capturing times TA1 to TAN may also be different. In some embodiments of the present invention, after the host receives the pieces of first depth information DA1 to DAN and the first capturing times TA1 to TAN, the host 110 can sort the first capturing times TA1 to TAN and generate an adjustment time corresponding to each of the depth capturing devices 1201 to 120N according to the first capturing times TA1 to TAN. Therefore, next time, when each of the depth capturing devices 1201 to 120N receives the synchronization signal from the host 110, each of the depth capturing devices 1201 to 120N can adjust the time for capturing the depth information according to the adjustment time.

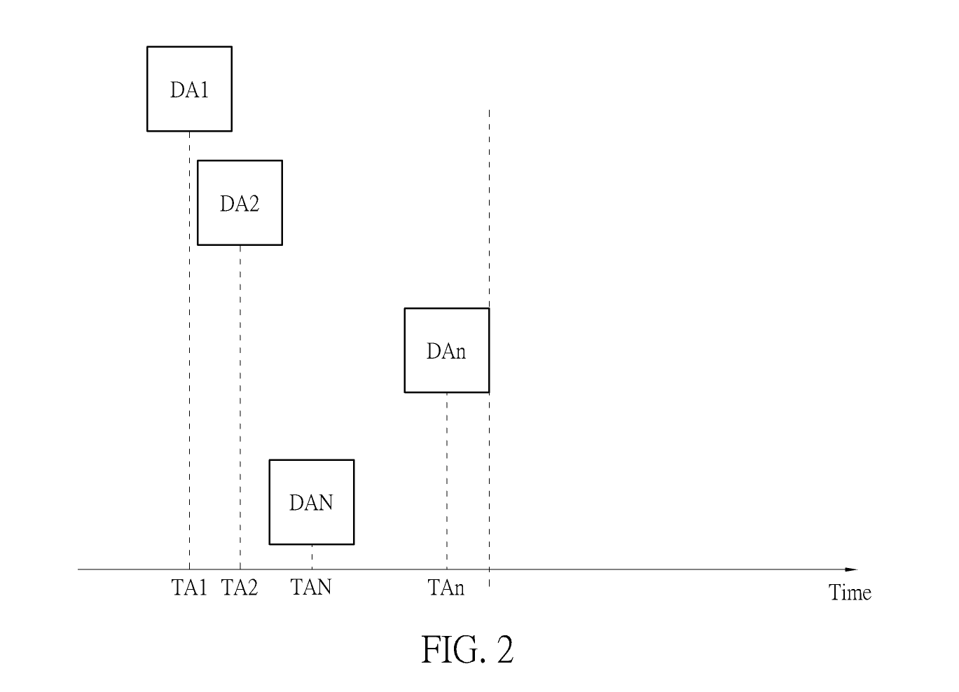

FIG. 2 shows the timing diagram of the first capturing times TA1 to TAN of the depth capturing devices 1201 to 120N. In FIG. 2, the first capturing time TA1 for capturing the piece of first depth information DA1 is the earliest among the first capturing times TA1 to TAN, and the first capturing time TAn is the latest among the first capturing times TA1 to TAN, where N≥1. To prevent the depth information from being combined unreasonably due to the large timing variation between the depth capturing devices 1201 to 120N, the host 110 can take the latest first capturing time TAn as a reference point, and request the depth capturing devices to capture depth information before the first capturing time TAn to postpone the capturing times. For example, in FIG. 2, the difference between the first capturing times TA1 and TAn may be 1.5 ms so the host 110 may set the adjustment time, for example, to be 1 ms, for the depth capturing device 1201 accordingly. Consequently, next time, when the host 110 transmits a second synchronization signal to the depth capturing device 1201, the depth capturing device 1201 would determine when to capture the piece of second depth information according to the adjustment time set by the host 110.

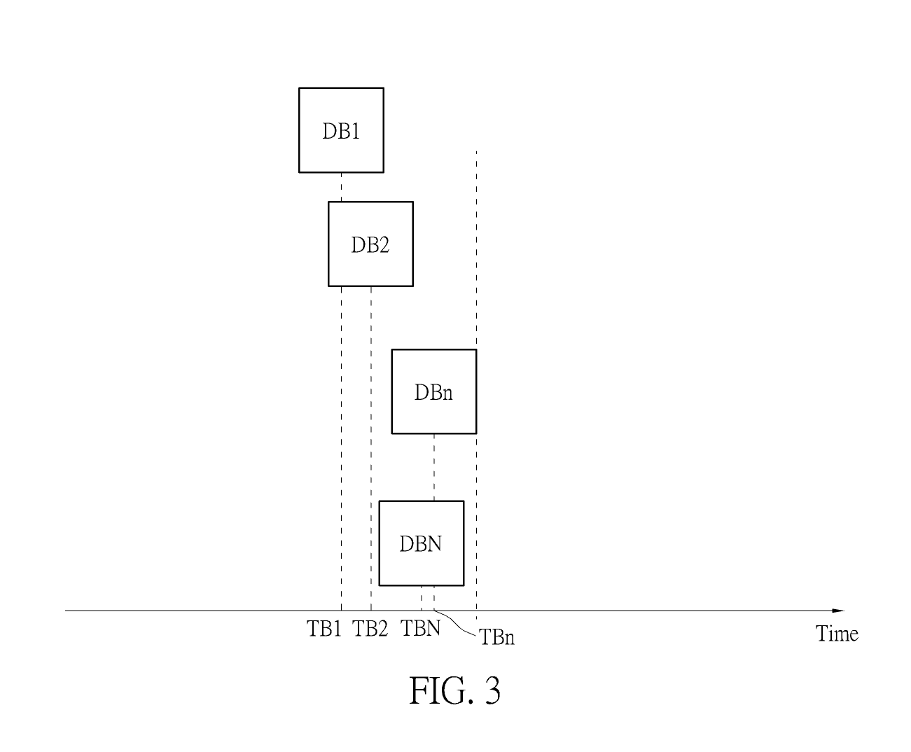

FIG. 3 shows the timing diagram of the second capturing times TB1 to TBN for capturing the pieces of second depth information DB1 to DBN after the depth capturing devices 1201 to 120N receive the second synchronization signal. In FIG. 3, when the depth capturing device 1201 receives the second synchronization signal, the depth capturing device 1201 will delay 1 ms and then capture the piece of second depth information DB1. Therefore, the difference between the second capturing time TB1 for capturing the piece of second depth information DB1 and the second capturing time TBn for capturing the piece of second depth information DBn can be reduced. In some embodiments, the host 110 can, for example but not limited to, delay the capturing times of the depth capturing devices 1201 to 120N by controlling the clock frequencies or the v-blank signals in image sensors of the depth capturing devices 1201 to 120N.

Similarly, the host 110 can set the adjustment times for the depth capturing devices 1202 to 120N according to their first capturing times TA2 to TAN. Therefore, the second capturing times TB1 to TBN of the depth capturing devices 1201 to 120N are more centralized in FIG. 3 than the first capturing times TA1 to TAN of the depth capturing devices 1201 to 120N in FIG. 2 overall. Consequently, the times at which the depth capturing devices 1201 to 120N capture the depth information can be better synchronized.

Furthermore, since the exterior and the interior conditions of the depth capturing devices 1201 to 120N can vary from time to time, for example the internal clock signals of the depth capturing devices 1201 to 120N may shift with different levels as time goes by, the host 110 can perform the synchronization function continuously in some embodiments, ensuring the depth capturing devices 1201 to 120N to keep generating the depth information synchronously.

In some embodiments of the present invention, the host 110 can use other approaches to perform the synchronization function. For example, the host 110 can send a series of timing signals to the depth capturing devices 1201 to 120N continuously. The series of timing signals sent by the host 110 include the updated timing information at the present, so when capturing the depth information, the depth capturing devices 1201 to 120N can record the capturing times according to the timing signals received when the corresponding pieces of depth information are captured and transmit the capturing times and the pieces of depth information to the host 110. In some embodiments, the distances between the depth capturing devices may be rather long, the time for the timing signals being received by the depth capturing devices may also be different, and the transmission times to the host 110 are also different. Therefore, the host 110 can reorder the capturing times of the depth capturing devices 1201 to 120N as shown in FIG. 2 after making adjustment according to different transmission times of the depth capturing devices. To prevent the depth information from being combined unreasonably due to the large timing variation between the depth capturing devices 1201 to 120N, the host 110 can generate the adjustment time corresponding to each of the depth capturing devices 1201 to 120N according to the capturing times TA1 to TAN, and the depth capturing devices 1201 to 120N can adjust a delay time or a frequency for capturing depth information.

For example, in FIG. 2, the host 110 can take the latest first capturing time TAn as a reference point, and request the depth capturing devices that capture the pieces of depth information before the first capturing time TAn to reduce their capturing frequencies or to increase their delay times. For example, the depth capturing device 1201 may reduce its capturing frequency or increase its delay time. Consequently, the depth capturing devices 1201 to 120N would become synchronized when capturing the depth information.

Although in the aforementioned embodiments, the host 110 can take the latest first capturing time TAn as the reference point to postpone other depth capturing devices, it is not to limit the present invention. In some other embodiments, if the system permits, the host 110 can also request the depth capturing device 120n to capture the depth information earlier or to speed up the capturing frequency to match with other depth capturing devices.

In addition, in some other embodiments, the adjustment times set by the host 110 are mainly used to adjust the times at which the depth capturing devices 1201 to 120N capture the exterior information for generating the depth information. For the synchronization between the right-eye image and the left-eye image required by the depth capturing devices 1201 to 120N when using the binocular vision, the internal clock signals of the depth capturing devices 1201 to 120N should be able to control the sensors for synchronization.

As mentioned, the host 110 may receive the pieces of depth information generated by the depth capturing devices 1201 to 120N at different times. In this case, to ensure the depth capturing devices 1201 to 120N can continue generating the depth information synchronously to provide the real-time 3D point cloud, the host 110 can set the scan period to ensure the depth capturing devices 1201 to 120N to generate the synchronized depth information periodically. In some embodiments, the host 110 can set the scan period according to the latest receiving time among the receiving times for receiving the depth information generated by the depth capturing devices 1201 to 120N. That is, the host 110 can take the depth capturing device that requires the longest transmission time among the depth capturing devices 1201 to 120N as a reference and set the scan period according to its transmission time. Consequently, it can be ensured that within a scan period, every depth capturing devices 1201 to 120N will be able to generate and transmit the depth information to the host 110 in time.

In addition, to prevent the depth processing system 100 from halting due to parts of the depth capturing devices being broken down, the host 110 can determine that the depth capturing devices have dropped their frames if the host 110 sends the synchronization signal and fails to receive any signals from those depth capturing devices within a buffering time after the scan period. In this case, the host 110 will move on to the next scan period so the other depth capturing devices can keep generating the depth information.

For example, the scan period of the depth processing system 100 can be 10 ms, and the buffering time can be 2 ms. In this case, after the host 110 sends the synchronization signal, if the host fails to receive the depth information generated by the depth capturing device 1201 within 12 ms, then the host 110 will determine that the depth capturing device 1201 has dropped its frame and will move on to the next scan period so as to avoid permanent idle.

In FIG. 1, the depth capturing devices 1201 to 120N can generate the depth information according to different methods, for example, some of the depth capturing devices may use structured light to improve the accuracy of the depth information when the ambient light or the texture on the object is not sufficient. For example, in FIG. 1, the depth capturing devices 1203 and 1204 may use the binocular vision algorithm to generate the depth information with the assistance of structured light. In this case, the depth processing system 100 can further include at least one structured light source 130. The structured light source 130 can emit structured light S1 to the specific region CR. In some embodiments of the present invention, the structured light S1 can project a specific pattern. When the structured light S1 is projected to the object, the specific pattern will be changed by different levels according to the surface information of the object. Therefore, according to the change of the pattern, the depth capturing device can derive the depth information about the surface information of the object.

In some embodiments, the structured light 130 can be separated from the depth capturing devices 1201 and 120N, and the structured light S1 projected by the structured light source 130 can be used by two or more depth capturing devices for generating the depth information. For example, in FIG. 1, the depth capturing devices 1203 and 1204 can both generate the depth information according to the structured light S1. In other words, different depth capturing devices can use the same structured light to generate the corresponding depth information. Consequently, the hardware design of the depth capturing devices can be simplified. Furthermore, since the structured light source 130 can be installed independently from the depth capturing devices 1201 to 120N, the structured light source 130 can be disposed closer to the object to be scanned without being limited by the position of the depth capturing devices 1201 to 120N so as to improve the flexibility of designing the depth processing system 100.

In addition, if the ambient light and the texture of the object are sufficient and the binocular vision algorithm alone is enough to generate accurate depth information meeting the requirement, then the structured light source 130 may not be necessary. In this case, the depth processing system 100 can turn off the structured light source 130, or even omit the structured light source 130 according to the usage situations.

In some embodiments, after the host 110 obtains the 3D point cloud, the host 110 can generate a mesh according to the 3D point cloud and generate the real-time 3D environment information according to the mesh. With the real-time 3D environment information corresponding to the specific region CR, the depth processing system 100 can monitor the object movement in the specific region CR and support many kinds of applications.

For example, in some embodiments, the user can track interested objects in the depth processing system 100 with, for example, face recognition, radio frequency identification, or card registration, so that the depth processing system 100 can identify the interested objects to be tracked. Then, the host 110 can use the real-time 3D environment information generated according to the mesh or the 3D point cloud to track the interested objects and determine the positions and the actions of the interested objects. For example, the specific region CR interested by the depth processing system 100 can be a target such as a hospital, nursing home, or jail. Therefore, the depth processing system 100 can monitor the action and the position of patients or prisoners and perform corresponding functions according to their actions. For example, if the depth processing system 100 determines that the patient has fallen down or the prisoner is breaking out of the prison, then a notification or a warning can be issued. Or, the depth processing system 100 can be applied to a shopping mall. In this case, the interested objects can be customers, and the depth processing system 100 can record the action routes of the customers, derive the shopping habits with big data analysis, and provide suitable services for customers.

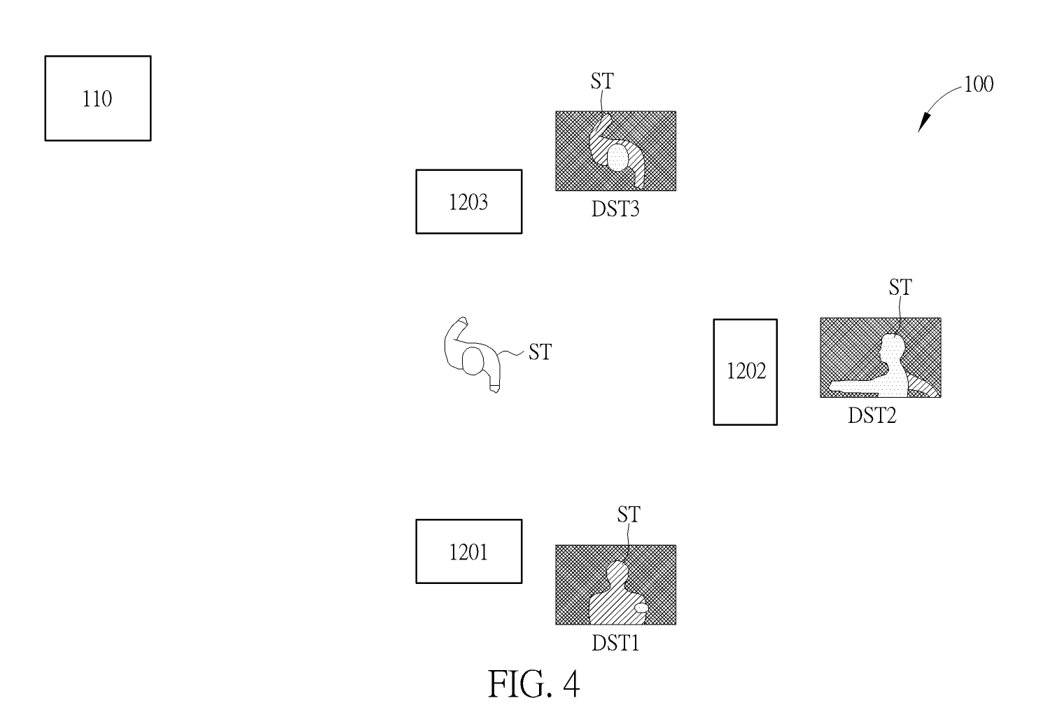

In addition, the depth processing system 100 can also be used to track the motion of the skeleton model. To track the motion of the skeleton model, the user can wear the costume with trackers or with special colors for the depth capturing devices 1201 to 120N in the depth processing system 100 to track the motion of each part of the skeleton model. FIG. 4 shows a usage situation when the depth processing system 100 is adopted to track the skeleton model ST. In FIG. 4, the depth capturing devices 1201 to 1203 of the depth processing system 100 can capture the depth information of the skeleton mode ST from different viewing points. That is, the depth capturing device 1201 can observe the skeleton model ST from the front, the depth capturing device 1202 can observe the skeleton model ST from the side, and the depth capturing device 1203 can observe the skeleton model ST from the top. The depth capturing devices 1201 to 1203 can respectively generate the depth maps DST1, DST2, and DST3 of the skeleton model ST according to their viewing points.

In prior art, when obtaining the depth information of the skeleton model from a single viewing point, the completed action of the skeleton model ST usually cannot be derived due to the limitation of the single viewing point. For example, in the depth map DST1 generated by the depth capturing device 1201, since the body of the skeleton model ST blocks its right arm, we are not able to know what the action of its right arm is. However, with the depth maps DST1, DST2, and DST3 generated by the depth capturing devices 1201 to 1203, the depth processing system 100 can integrate the completed action of the skeleton model ST.

In some embodiments, the host 110 can determine the actions of the skeleton model ST in the specific region CR according to the moving points in the 3D point cloud. Since the points remain still in a long time may belong to the background while the moving points are more likely to be related to the skeleton model ST, the host 110 can skip the calculation for regions with still points and focus on regions with moving points. Consequently, the computation burden of the host 110 can be reduced.

Furthermore, in some other embodiments, the host 110 can generate the depth information of the skeleton model ST corresponding to different view points according to the real-time 3D environment information provided by the mesh to determine the action of the skeleton model ST. In other words, in the case that the depth processing system 100 has already derived the completed 3D environment information, the depth processing system 100 can generate depth information corresponding to the virtual viewing points required by the user. For example, after the depth processing system 100 obtains the completed 3D environment information, the depth processing system 100 can generate the depth information with viewing points in front of, in back of, on the left of, on the right of, and/or above the skeleton model ST. Therefore, the depth processing system 100 can determine the action of the skeleton model ST according to the depth information corresponding to these different viewing points, and the action of the skeleton model can be tracked accurately.

In addition, in some embodiments, the depth processing system 100 can also transform the 3D point cloud to have a format compatible with the machine learning algorithms. Since the 3D point cloud does not have a fixed format, and the recorded order of the points are random, it can be difficult to be adopted by other applications. The machine learning algorithms or the deep learning algorithms are usually used to recognize objects in two-dimensional images. However, to process the two-dimensional image for object recognition efficiently, the two-dimensional images are usually stored in a fixed format, for example, the image can be stored with pixels having red, blue, and green color values and arranged row by row or column by column. Corresponding to the two-dimensional images, the 3D images can also be stored with voxels having red, blue and green color values and arranged according to their positions in the space.

However, the depth processing system 100 is mainly used to provide depth information of objects, so whether to provide the color information or not is often an open option. And sometimes, it is also not necessary to recognize the objects with their colors for the machine learning algorithms or the deep learning algorithms. That is, the object may be recognized simply by its shape. Therefore, in some embodiments of the present invention, the depth processing system 100 can store the 3D point cloud as a plurality of binary voxels in a plurality of unit spaces for the usage of the machine learning algorithms or the deep learning algorithms.

For example, the host 110 can divide the space containing the 3D point cloud into a plurality of unit spaces, and each of the unit spaces is corresponding to a voxel. The host 110 can determine the value of each voxel by checking if there are more than a predetermined number of points in the corresponding unit space. For example, when a first unit space has more than a predetermined number of points, for example, more than 10 points, the host 110 can set the first voxel corresponding to the first unit space to have a first bit value, such as 1, meaning that there is an object existed in the first voxel. Contrarily, when a second unit space has no more than a predetermined number of points, the host 110 can set the second voxel corresponding to the second unit space to have a second bit value, such as 0, meaning that there's no object in the second voxel. Consequently, the point cloud can be stored in a binary voxel format, allowing the depth information generated by the depth processing system 100 to be adopted widely by different applications while saving the memory space.

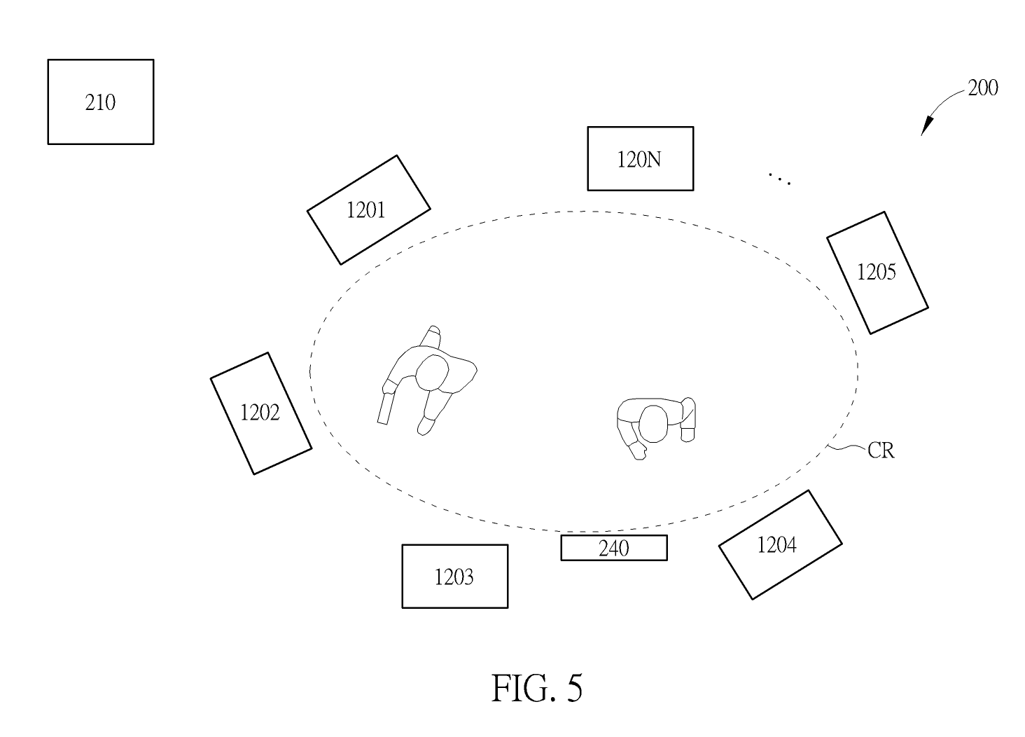

FIG. 5 shows a depth processing system 200 according to another embodiment of the present invention. The depth processing systems 100 and 200 have similar structures and can be operated with similar principles. However, the depth processing system 200 further includes an interactive device 240. The interactive device 240 can perform a function corresponding to an action of a user within an effective scope of the interactive device 240. For example, the depth processing system 200 can be disposed in a shopping mall, and the depth processing system 200 can be used to observe the actions of the customers. The interactive device 240 can, for example, include a display panel. When the depth processing system 200 identifies that a customer is walking into the effective scope of the interactive device 240, the depth processing system 200 can further check the customer's identification and provide information possibly needed by the customer according to his/her identification. For example, according to the customer's consuming history, corresponding advertisement which may interest the customer can be displayed. In addition, since the depth processing system 200 can provide the depth information about the customer, the interactive device 240 can also interact with the customer by determining the customer's actions, such as displaying the item selected by the customer with his/her hand gestures.

In other words, since the depth processing system 200 can provide the completed 3D environment information, the interactive device 240 can obtain the corresponding depth information without capturing or processing the depth information. Therefore, the hardware design can be simplified, and the usage flexibility can be improved.

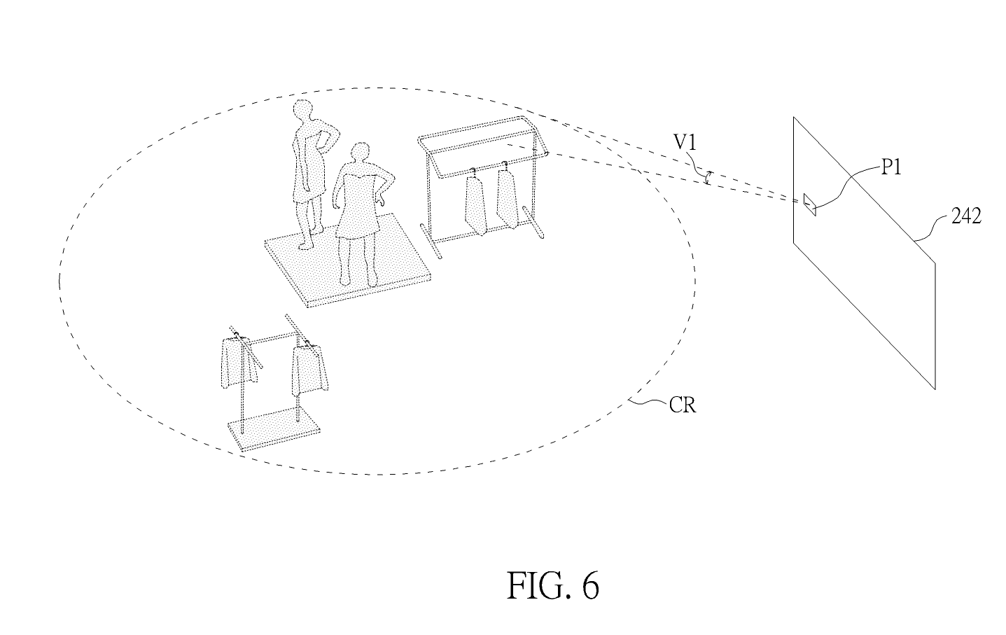

In some embodiments, the host 210 can provide the depth information corresponding to the virtual viewing point of the interactive device 240 according to the 3D environmental information provided by the mesh or the 3D point cloud so the interactive device 240 can determine the user's actions and the positions relative to the interactive device 240 accordingly. For example, FIG. 6 shows the 3D point cloud generated by the depth processing system 200. The depth processing system 200 can choose the virtual viewing point according to the position of the interactive device 240 and generate the depth information corresponding to the interactive device 240 according to the 3D point cloud in FIG. 6. That is, the depth processing system 200 can generate the depth information of the specific region CR as if it were observed by the interactive device 240.

In FIG. 6, the depth information of the specific region CR observed from the position of the interactive device 240 can be presented by the depth map 242. In the depth map 242, each pixel can be corresponding to a specific viewing field when observing the specific region CR from the interactive device 240. For example, in FIG. 6, the content of the pixel P1 is generated by the observing result with the viewing field V1. In this case, the host 210 can determine which is the nearest object in the viewing field V1 when watching objects from the position of the interactive device 240. In the viewing field V1, since the further object would be blocked by the closers object, the host 210 will take the depth of the object nearest to the interactive device 240 as the value of the pixel P1.

In addition, when using the 3D point cloud to generate the depth information, since the depth information may be corresponding to a viewing point different from the viewing point for generating the 3D point cloud, defects and holes may appear in some parts of the depth information due to lack of information. In this case, the host 210 can check if there are more than a predetermined number of points in a predetermined region. If there are more than the predetermined number of points, meaning that the information in the predetermined region is rather reliable, then the host 210 can choose the distance from the nearest point to the projection plane of the depth map 242 to be the depth value, or derive the depth value by combining different distance values with proper weightings. However, if there are no more than the predetermined number of points in such predetermined region, then the host 210 can further expand the region until the host 210 can finally find enough points in the expanded region. However, to prevent the host 210 from expanding the region indefinitely and causing depth information with an unacceptable inaccuracy, the host 210 can further limit the number of expansions. Once the host 210 can not find enough points after the limited number of expansions, the pixel would be set as invalid.

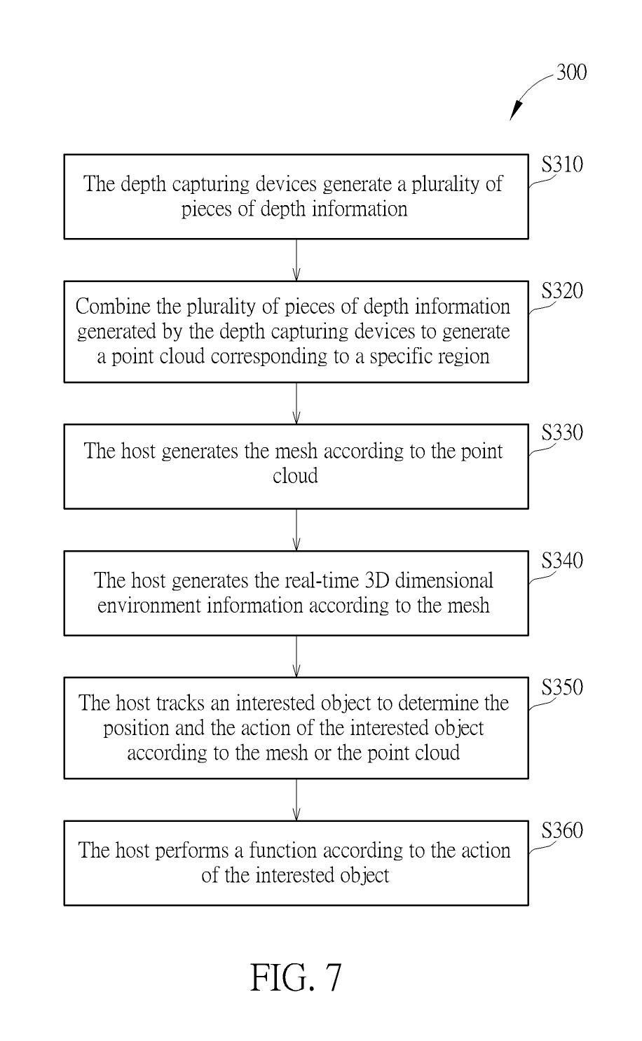

FIG. 7 shows a flow chart of an operating method 300 of the depth processing system 100 according to one embodiment of the present invention. The method 300 includes steps S310 to S360.

S310: the depth capturing devices 1201 to 120N generate a plurality of pieces of depth information;

S320: combine the plurality of pieces of depth information generated by the depth capturing devices 1201 to 120N to generate a point cloud corresponding to a specific region CR;

S330: the host 110 generates the mesh according to the point cloud;

S340: the host 110 generates the real-time 3D dimensional environment information according to the mesh;

S350: the host 110 tracks an interested object to determine the position and the action of the interested object according to the mesh or the point cloud;

S360: the host 110 performs a function according to the action of the interested object.

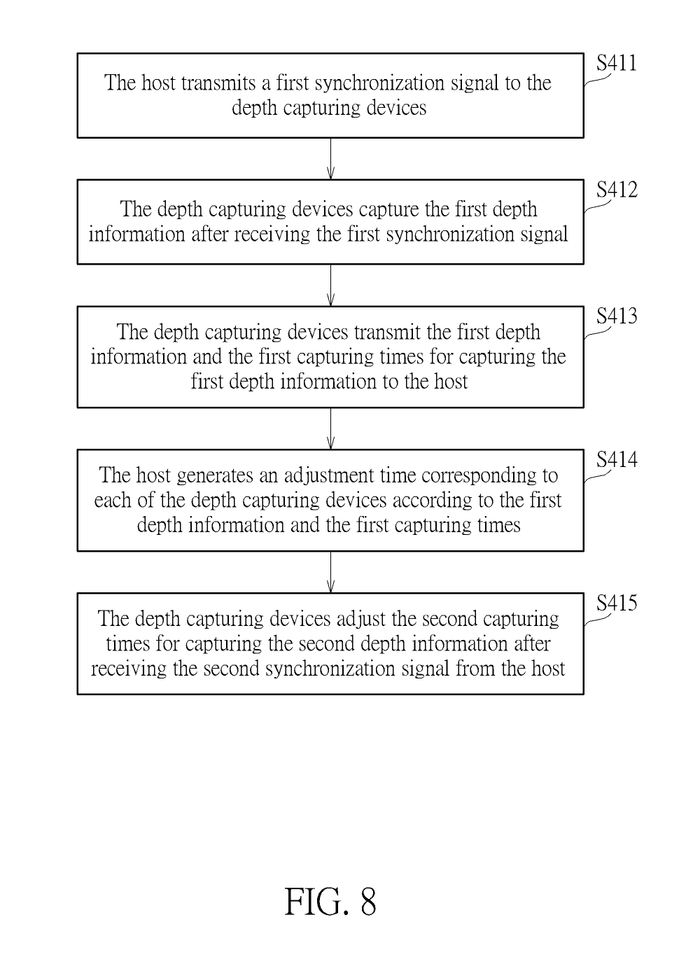

In some embodiments, to allow the depth capturing devices 1201 to 120N to generate the depth information synchronously for producing the point cloud, the method 300 can further include a step for the host 110 to perform a synchronization function. FIG. 8 shows a flow chart for performing the synchronization function according to one embodiment of the present invention. The method for performing the synchronization function can include steps S411 to S415.

S411: the host 110 transmits a first synchronization signal SIG1 to the depth capturing devices 1201 to 120N;

S412: the depth capturing devices 1201 to 120N capture the first depth information DA1 to DAN after receiving the first synchronization signal SIG1;

S413: the depth capturing devices 1201 to 120N transmit the first depth information DA1 to DAN and the first capturing times TA1 to TAN for capturing the first depth information DA1 to DAN to the host 110;

S414: the host 110 generates an adjustment time corresponding to each of the depth capturing devices 1201 to 120N according to the first depth information DA1 to DAN and the first capturing times TA1 to TAN;

S415: the depth capturing devices 1201 to 120N adjust the second capturing times TB1 to TBN for capturing the second depth information DB1 to DBN after receiving the second synchronization signal from the host 110.

With the synchronization function, the depth capturing devices 1201 to 120N can generate the depth information synchronously. Therefore, in step S320, the depth information generated by the depth capturing devices 1201 to 120N can be combined to a uniform coordinate system for generating the 3D point cloud of the specific region CR according to the positions and the capturing angles of the depth capturing devices 1201 to 120N.

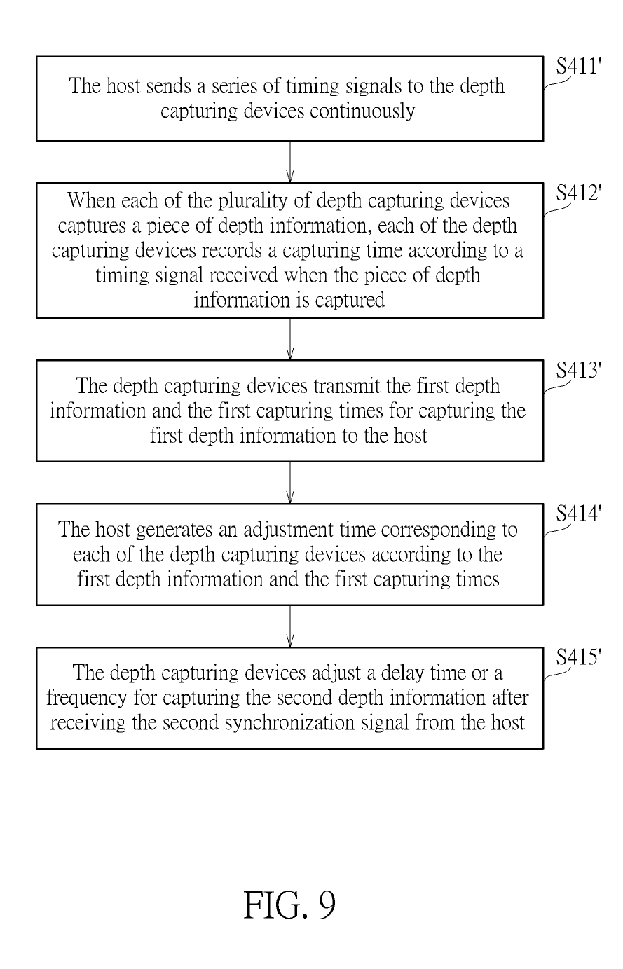

In some embodiments, the synchronization function can be performed by other approaches. FIG. 9 shows a flow chart for performing the synchronization function according to another embodiment of the present invention. The method for performing the synchronization function can include steps S411′ to S415′.

S411′: the host 110 sends a series of timing signals to the depth capturing devices 1201 to 120N continuously;

S412′: when each of the plurality of depth capturing devices 1201 to 120N captures a piece of depth information DA1 to DAN, each of the depth capturing devices 1201 to 120N records a capturing time according to a timing signal received when the piece of depth information DA1 to DAN is captured;

S413′: the depth capturing devices 1201 to 120N transmit the first depth information DA1 to DAN and the first capturing times TA1 to TAN for capturing the first depth information DA1 to DAN to the host 110;

S414′: the host 110 generates an adjustment time corresponding to each of the depth capturing devices 1201 to 120N according to the first depth information DA1 to DAN and the first capturing times TA1 to TAN;

S415′: the depth capturing devices 1201 to 120N adjust a delay time or a frequency for capturing the second depth information after receiving the second synchronization signal from the host 110.

In addition, in some embodiments, the host 110 may receive the depth information generated by the depth capturing devices 1201 to 120N at different times, and the method 300 can also have the host 110 set the scan period according to the latest receiving time of the plurality of receiving times, ensuring every depth capturing devices 1201 to 120N will be able to generate and transmit the depth information to the host 110 in time within a scan period. Also, if the host 110 sends the synchronization signal and fails to receive any signals from some depth capturing devices within a buffering time after the scan period, then the host 110 can determine that those depth capturing devices have dropped their frames and move on to the following operations, preventing the depth processing system 100 from idling indefinitely.

After the mesh and the 3D environment information corresponding to the specific region CR are generated in the steps S330 and S340, the depth processing system 100 can be used in many applications. For example, when the depth processing system 100 is applied to a hospital or a jail, the depth processing system 100 can track the positions and the actions of patients or prisoners through steps S350 and S360, and perform the corresponding functions according to the positions and the actions of the patients or the prisoners, such as providing assistance or issuing notifications.

In addition, the depth processing system 100 can also be applied to a shopping mall. In this case, the method 300 can further record the action route of the interested object, such as the customers, derive the shopping habits with big data analysis, and provide suitable services for the customers.

In some embodiments, the method 300 can also be applied to the depth processing system 200. Since the depth processing system 200 further includes an interactive device 240, the depth processing system 200 can provide the depth information corresponding to the virtual viewing point of the interactive device 240 so the interactive device 240 can determine the user's actions and the positions corresponding to the interactive device 240 accordingly. When a customer is walking into the effective scope of the interactive device 240, the interactive device 240 can perform functions corresponding to the customer's actions. For example, when the user moves closer, the interactive device 240 can display the advertisement or the service items, and when the user changes his/her gestures, the interactive device 240 can display the selected item accordingly.

In addition, the depth processing system 100 can also be applied to track the motions of skeleton models. For example, the method 300 may include the host 110 generating a plurality of pieces of depth information with respect to different viewing points corresponding to the skeleton model in the specific region CR according to the mesh for determining the action of the skeleton model, or determine the action of the skeleton model in the specific region CR according to a plurality of moving points in the 3D point cloud.

Furthermore, in some embodiments, to allow the real-time 3D environment information generated by the depth processing system 100 to be widely applied, the method 300 can also include storing the 3D information generated by the depth processing system 100 in a binary-voxel format. For example, the method 300 can include the host 110 dividing the space containing the 3D point cloud into a plurality of unit spaces, where each of the unit spaces is corresponding to a voxel. When a first unit space has more than a predetermined number of points, the host 110 can set the voxel corresponding to the first unit space to have a first bit value. Also, when a second unit space has no more than the predetermined number of points, the host 110 can set the voxel corresponding to the second unit space to have a second bit value. That is, the depth processing system 100 can store the 3D information as binary voxels without color information, allowing the 3D information to be used by machine learning algorithms or deep learning algorithms.

In summary, the depth processing system provided by the embodiments of the present invention can have depth capturing devices disposed at different locations to generate depth information synchronously and to generate completed 3D environmental information for many kinds of applications, such as monitoring interested objects, analyzing skeleton model, and providing the 3D environmental information for other interactive devices. Therefore, the hardware design for the interactive devices can be simplified, and the usage flexibility can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A depth processing system comprising:
a plurality of depth capturing devices disposed around a specific region, and each configured to generate a piece of depth information according to its own corresponding viewing point; and
a host configured to combine a plurality of pieces of depth information generated by the plurality of depth capturing devices to generate a three-dimensional point cloud corresponding to the specific region according a relative space status of the plurality of depth capturing devices.

2. The depth processing system of claim 1, wherein the host is further configured to perform a synchronization function to control the plurality of depth capturing devices to generate the plurality of pieces of depth information synchronously.

3. The depth processing system of claim 2, wherein when the host performs the synchronization function:
the host sends a first synchronization signal to the plurality of depth capturing devices;
after receiving the first synchronization signal, each of the plurality of depth capturing devices captures a first piece of depth information and transmits a first capturing time of capturing the first piece of depth information and the first piece of depth information to the host;
the host generates an adjustment time corresponding to each of the plurality of depth capturing devices according to the first capturing time; and
after receiving a second synchronization signal from the host, each of the plurality of depth capturing devices adjusts a second capturing time of capturing a second piece of depth information according to the adjustment time.

4. The depth processing system of claim 2, wherein when the host performs the synchronization function:
the host sends a series of timing signals to the plurality of depth capturing devices continuously;
when each of the plurality of depth capturing devices captures a piece of depth information, each of the plurality of depth capturing devices records a capturing time according to a timing signal received when the piece of depth information is captured, and transmit the capturing time and the piece of depth information to the host;
the host generates an adjustment time corresponding to each of the plurality of depth capturing devices according to the capturing time; and
each of the plurality of depth capturing devices adjusts a delay time or a frequency for capturing depth information according to the adjustment time.

5. The depth processing system of claim 1, wherein:
the host receives the plurality of pieces of depth information generated by the plurality of depth capturing devices at a plurality of receiving times;
the host sets a scan period of the plurality of depth capturing devices according to a latest receiving time of the plurality of receiving times; and
after the host sends a synchronization signal, if the host fails to receive any signal from a depth capturing device of the plurality of depth capturing devices within a buffering time after the scan period, the host determines that the depth capturing device has dropped a frame.

6. The depth processing system of claim 1, further comprising a structured light source configured to emit structured light to the specific region, wherein at least two depth capturing devices of the plurality of depth capturing devices generate at least two pieces of depth information according to the structured light.

7. The depth processing system of claim 1, wherein:
the host is further configured to generate a mesh according to the three-dimensional point cloud, and generate real-time three-dimensional environment information corresponding to the specific region according to the mesh.

8. The depth processing system of claim 7, further comprising an interactive device configured to perform a function corresponding to an action of a user within an effective scope of the interactive device, wherein the host is further configured to provide depth information corresponding to a virtual viewing point of the interactive device according to the mesh or the three-dimensional point cloud to help the interactive device to identify the action and a position of the user relative to the interactive device.

9. The depth processing system of claim 7, wherein the host is further configured to track an interested object according to the mesh or the three-dimensional point cloud to identify a position and an action of the interested object.

10. The depth processing system of claim 9, wherein the host is further configured to perform a notification function or record an action route of the interested object according the action of the interested object.

11. The depth processing system of claim 7, wherein the host is further configured to generate depth information of a skeleton model from a plurality of different viewing points according to the mesh to determine an action of the skeleton model in the specific region.

12. The depth processing system of claim 1, wherein the host is further configured to determine an action of the skeleton model in the specific region according to a plurality of moving points in the three-dimensional point cloud.

13. The depth processing system of claim 1, wherein:
the host is further configured to divide a space containing the three-dimensional point cloud into a plurality of unit spaces;
each of the unit spaces is corresponding to a voxel;
when a first unit space has more than a predetermined number of points, a voxel corresponding to the first unit space has a first bit value; and
when a second unit space has no more than the predetermined number of points, a voxel corresponding to the second unit space has a second bit value.

14. A depth processing system comprising:
a plurality of depth capturing devices disposed around a specific region, and each configured to generate a piece of depth information according to its own corresponding viewing point; and
a host configured to control a plurality of capturing times at which the plurality of depth capturing devices capture a plurality of pieces of depth information, and combine the plurality of pieces of depth information to generate a three-dimensional point cloud corresponding to the specific region according a relative space status of the plurality of depth capturing devices.
